(19) United States
(12) Patent Application Publication
(10) Pub. No.: US 2018/0119388 A1
(43) Pub. Date: May 3, 2018

(54) CONTROL SYSTEM FOR CONSTRUCTION MACHINE

(71) Applicant: KYB Corporation, Tokyo (JP)

(72) Inventors: Masahiro EGAWA, Saitama (JP); Haruhiko KAWASAKI, Kanagawa (JP)

(73) Assignee: KYB Corporation, Tokyo (JP)

(21) Appl. No.: 15/567,646

(22) PCT Filed: Jun. 1, 2016
(86) PCT No.: PCT/JP2016/066142

§ 371 Date: Oct. 19, 2017

(30) Foreign Application Priority Data
Jun. 29, 2015 (JP) 2015-129852

(51) Int. Cl. E02F 9/22

(52) U.S. Cl. CPC E02F 9/2225; E02F 9/2217; E02F 9/2285; F15B 11/08; E02F 9/2271; E02F 9/2292; E02F 9/2296; E02F 9/2267

(57) ABSTRACT

A control system for a construction machine includes a fluid pressure pump, a fluid pressure actuator having a load-side pressure chamber and an anti-load side pressure chamber, an operation valve switched to supply the working oil to the anti-load side pressure chamber and to discharge the working oil from the load-side pressure chamber when the pilot pressure is led to the pilot chamber on the basis of an operation by an operator, a regenerative flow rate control valve switched to lead a part of the working oil discharged from the load-side pressure chamber to the anti-load side pressure chamber when the pilot pressure is led to the pilot chamber, a pilot communication flow passage for allowing the pilot chamber and the pilot chamber to communicate, and a switching valve for switching the pilot communication flow passage between a communication state and a shut-off state.

### TECHNICAL FIELD

The present invention relates to a control system for a construction machine.

### BACKGROUND ART

JP2013-200023A discloses a construction machine in which, when an operator operates an operation lever, a boom switching valve is switched by a pilot pressure and a regenerative flow rate control valve is switched by the same pilot pressure. In this construction machine, the regenerative flow rate control valve is switched to an open state when a boom cylinder is operated to be lowered, and a part of a working oil discharged from a piston-side chamber (load-side pressure chamber) is led to a rod-side chamber as a regenerative flow rate. As a result, the rod-side chamber is prevented from becoming a negative pressure when a lowering speed of the boom cylinder is increased.

### SUMMARY OF INVENTION

However, in the construction machine described in JP2013-200023A, since regeneration is performed with an operation of the operation lever even if the regeneration is not required in the lowering operation of the boom cylinder, adjustment of the lowering speed of the boom cylinder by the operator becomes difficult in some cases.

The present invention has an object to facilitate adjustment of operability of a fluid pressure actuator by the operator.

According to an aspect of the present invention, a control system for a construction machine, includes: a fluid pressure pump configured to supply a working fluid; a fluid pressure actuator having a load-side pressure chamber and an anti-load side pressure chamber to/from which the working fluid from the fluid pressure pump is fed/discharged; an operation valve having a pilot chamber to which a pilot pressure is led on the basis of an operation by an operator, the operation valve being switched to supply the working fluid to the anti-load side pressure chamber from the fluid pressure pump and to discharge the working fluid from the load-side pressure chamber when the pilot pressure is led to the pilot chamber; a regenerative flow rate control valve having a pilot chamber to which a pilot pressure is led, the regenerative flow rate control valve being switched to lead a part of the working fluid discharged from the load-side pressure chamber to the anti-load side pressure chamber when the pilot pressure is led to the pilot chamber; a pilot communication flow passage configured to allow the pilot chamber of the operation valve and the pilot chamber of the regenerative flow rate control valve to communicate; and a switching valve configured to switch the pilot communication flow passage between a communication state and a shut-off state.

### BRIEF DESCRIPTION OF DRAWINGS

FIG. 1 is a circuit diagram of a control system for a construction machine according to a first embodiment of the present invention.

FIG. 2 is a circuit diagram of a control system for a construction machine according to a second embodiment of the present invention.

### DESCRIPTION OF EMBODIMENTS

Referring to the attached drawings, embodiments of the present invention will be described below.

In each of the embodiments below, a case where a construction machine is a hybrid construction machine and particularly it is a hybrid hydraulic excavator (hereinafter simply referred to as a “hydraulic excavator”) will be described. In each of the embodiments below, the fluid pressure actuator is a boom cylinder 30 for elevating a boom as a load of the hydraulic excavator. In the hydraulic excavator, a working oil is used as a working fluid.

### First Embodiment

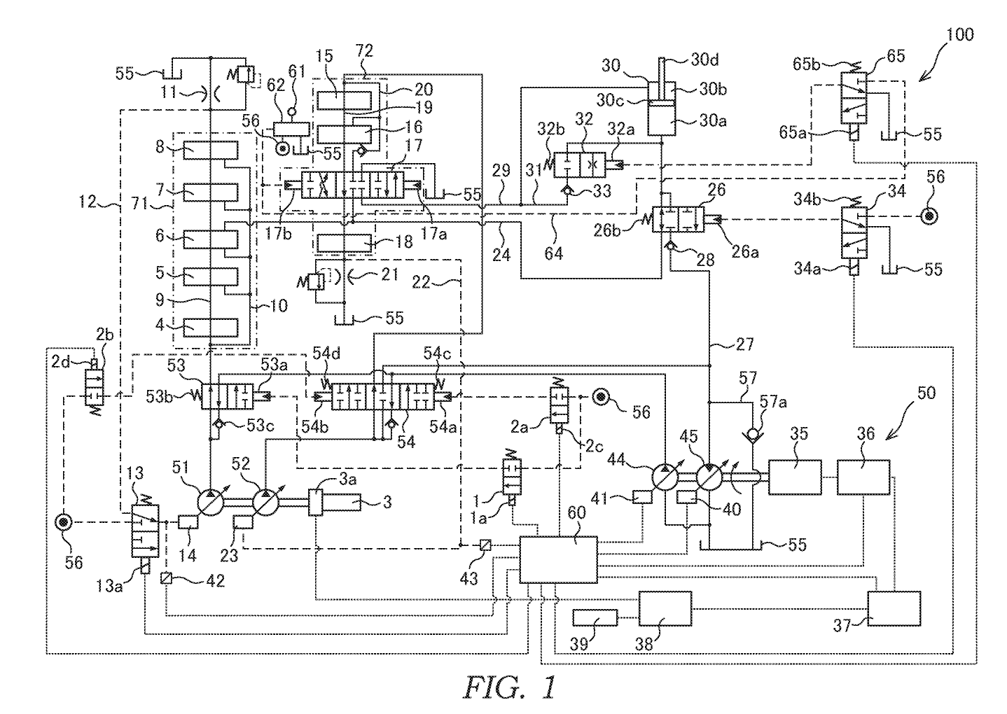

By referring to FIG. 1, a control system for a construction machine (hereinafter simply referred to as a “control system”) 100 according to a first embodiment of the present invention will be described below.

As illustrated in FIG. 1, the control system 100 includes a variable displacement type first main pump 51 and a variable displacement type second main pump 52, and a variable displacement type assist pump 44.

A discharged oil of the first main pump 51 is supplied to a first circuit system 71 through a first switching valve 53. A discharged oil from the second main pump 52 is supplied to a second circuit system 72 through a second switching valve 54. A discharged oil of the assist pump 44 can merge with the discharged oil of the first main pump 51 through the first switching valve 53 and also can merge with the discharged oil of the second main pump 52 through the second switching valve 54. The first main pump 51 and the second main pump 52 correspond to fluid pressure pumps.

The first switching valve 53 is a 4-port 2-position spool type switching valve. The first switching valve 53 has a pilot chamber 53a provided by facing one end of a spool, and the other end of the spool is elastically supported by a spring 53b. The first switching valve 53 is held at a normal position by an urging force of the spring 53b in a state where the pilot pressure is not supplied to the pilot chamber 53a (state illustrated in FIG. 1).

The first switching valve 53 supplies the discharged oil of the first main pump 51 to the first circuit system 71 and also merges the discharged oil of the assist pump 44 with the discharged oil of the first main pump 51 through a check valve 53c in a state held at the normal position.

When the first switching valve 53 is switched to a switching position (right-side position in FIG. 1) by the pilot pressure of the pilot chamber 53a, it shuts off the merging of the discharged oil of the assist pump 44 and the discharged oil of the first main pump 51. At this time, the discharged oil of the first main pump 51 is still supplied to the first circuit system 71.

The second switching valve 54 is a 6-port 3-position spool type switching valve. In the second switching valve 54, pilot chambers 54a and 54b are provided by facing both ends of a spool, respectively. The spool is supported at a neutral state by a pair of centering springs 54c and 54d provided on both ends, respectively. The second switching valve 54 is usually held at the normal position by an urging force of the centering springs 54c and 54d (state illustrated in FIG. 1).

The second switching valve 54 supplies the discharged oil of the second main pump 52 to a second circuit system 72 and merges the discharged oil of the assist pump 44 with the discharged oil of the second main pump 52 in the state held at the normal position.

When the second switching valve 54 is switched to a first switching position (right-side position in FIG. 1) by a pilot pressure of one of the pilot chambers 54a, it shuts off merging of the discharged oil of the assist pump 44 and the discharged oil of the second main pump 52. At this time, the discharged oil of the second main pump 52 is still supplied to the second circuit system 72.

When the second switching valve 54 is switched to a second switching position (left-side position in FIG. 1) by the pilot pressure of the other pilot chamber 54b, merging of the discharged oil of the assist pump 44 and the discharged oil of the second main pump 52 and supply of the discharged oil of the second main pump 52 to the second circuit system 72 are both shut off.

At this time, the discharged oil of the second main pump 52 is supplied to a regeneration motor 45 driving the assist pump 44. At the normal position and the first switching position, the supply of the discharged oil of the second main pump 52 to the regeneration motor 45 is shut off. The first switching valve 53 may be constituted the same as the second switching valve 54 so that the discharged oil of the first main pump 51 is supplied to the regeneration motor 45.

To the pilot chamber 53a of the first switching valve 53, a pilot pressure oil is supplied from a pilot hydraulic source 56 through a solenoid valve 1. The solenoid valve 1 shuts off the pilot chamber 53a from the pilot hydraulic source 56 when a solenoid 1a is at a non-excited normal position (state illustrated in FIG. 1). The solenoid valve 1 is switched to a communication position (lower-side position in FIG. 1) where the discharged oil of the pilot hydraulic source 56 is supplied to the pilot chamber 53a since the solenoid 1a is excited.

One of the pilot chambers 54a of the second switching valve 54 is connected to the pilot hydraulic source 56 through a solenoid valve 2a. The other pilot chamber 54b of the second switching valve 54 is connected to the pilot hydraulic source 56 through a solenoid valve 2b. The solenoid valve 2a and the solenoid valve 2b shut off the pilot chambers 54a and 54b from the pilot hydraulic source 56 when solenoids 2c and 2d are at non-excited normal positions (state illustrated in FIG. 1). The solenoid valve 2a and the solenoid valve 2b are switched to communication positions where the discharged oil of the pilot hydraulic source 56 is supplied to the pilot chambers 54a and 54b since the solenoids 2c and 2d are excited.

Each of the solenoids 1a, 2c, and 2d of the solenoid valve 1, the solenoid valve 2a, and the solenoid valve 2b is connected to a controller 60 as a control part.

The controller 60 controls an operation of the hydraulic excavator. The controller 60 includes a CPU (central processing unit), a ROM (read only memory) in which a control program, a set value and the like required for a processing operation of the CPU are stored, and a RAM (random access memory) in which information detected by various sensors is stored temporarily.

The controller 60 excites or non-excites each of the solenoids 1a, 2c, and 2d of the solenoid valve 1, the solenoid valve 2a, and the solenoid valve 2b in accordance with the input signal on the bases of the operation by the operator of the hydraulic excavator.

The first main pump 51 and the second main pump 52 are rotated/driven by an engine 3 including a rotation speed sensor (not shown). To the engine 3, a power generator 3a for generating power using excess torque is attached.

In the first circuit system 71 connected to the first main pump 51, an operation valve 4 controlling a turning motor, an operation valve 5 controlling an arm cylinder, an operation valve 6 for a boom dual-speed controlling the boom cylinder 30, an operation valve 7 controlling spare attachment, and an operation valve 8 controlling a left-hand side traveling motor are provided from an upstream side. The operation valves 4 to 8 are connected to each other through a neutral flow passage 9 and a parallel flow passage 10 provided in parallel with each other and connected to the first main pump 51 through the first switching valve 53.

On a downstream of the operation valve 8 for the left-hand side traveling motor in the neutral flow passage 9, a throttle 11 for controlling a pilot pressure for generating a pilot pressure is provided. The throttle 11 generates a high pilot pressure on an upstream side if a flow rate is large, while it generates a low pilot pressure on the upstream side if a flow rate is small.

Specifically, the neutral flow passage 9 leads the whole of or a part of the working oil supplied from the first main pump 51 to the first circuit system 71 through the throttle 11 to a tank 55 when the operation valves 4 to 8 are at a neutral position or in the vicinity of the neutral position. At this time, since the flow rate of the working oil passing through the throttle 11 increases, a high pilot pressure is generated.

On the other hand, in the neutral flow passage 9, if the operation valves 4 to 8 are switched to a full-stroke state, communication of a fluid is withdrawn. In this case, since the flow rate of the working oil flowing through the throttle 11 is withdrawn, the pilot pressure becomes zero. Depending on operation amounts of the operation valves 4 to 8, a part of the working oil is led to an actuator, while the remaining is led from the neutral flow passage 9 to the tank 55. Thus, the throttle 11 generates a pilot pressure according to the flow rate of the working oil flowing through the neutral flow passage 9. As described above, the throttle 11 generates the pilot pressure according to the operation amounts of the operation valves 4 to 8 located on the upstream side.

Between the operation valve 8 and the throttle 11 in the neutral flow passage 9, a pilot flow passage 12 is connected. The pilot flow passage 12 is connected to a regulator 14 controlling a tilting angle of a swash plate of the first main pump 51 through a solenoid switching valve 13.

The solenoid switching valve 13 is a valve for supplying the pilot pressure oil to the regulator 14. The solenoid switching valve 13 supplies the pilot pressure oil selected from the pilot flow passage 12 and the pilot hydraulic source 56 in accordance with its position to the regulator 14. The solenoid switching valve 13 at the normal position supplies the pressure of the pilot flow passage 12 as a pilot pressure to the regulator 14 (state illustrated in FIG. 1). Upon receipt of supply of an excitation current, the solenoid switching valve 13 is switched to the switching position (lower-side position in FIG. 1) and supplies the pressure of the pilot hydraulic source 56 as the pilot pressure to the regulator 14.

A solenoid 13a of the solenoid switching valve 13 is connected to the controller 60. The controller 60 supplies the excitation current to the solenoid 13a and switches it to the switching position in accordance with an input signal from the operator of the hydraulic excavator. On the other hand, the controller 60 non-excites the solenoid 13a and holds the solenoid switching valve 13 at the normal position unless the signal is input by the operator.

The regulator 14 controls the tilting angle of the swash plate of the first main pump 51 so as to be in proportion to (proportion constant is a negative number) to the pilot pressure and sets a working oil discharge capacity per one rotation of the first main pump 51.

The solenoid switching valve 13 plays a role of reducing a discharge amount of the first main pump 51 smaller than the other cases when all the operation valves 4 to 8 are held at the normal positions, that is, when the turning motor, the arm cylinder, the boom cylinder 30, the spare attachment, and the left-hand side traveling motor are not operated. A warm-up operation when an energy loss is to be reduced corresponds to this condition, for example.

In the second circuit system 72 connected to the second main pump 52, an operation valve 15 controlling a right-hand side traveling motor, an operation valve 16 controlling a bucket cylinder, a boom operation valve 17 controlling the boom cylinder 30, and an operation valve 18 for arm dual-speed for controlling an arm cylinder are provided from an upstream side. The operation valves 15 to 18 are connected to each other through a neutral flow passage 19 and are connected to the second main pump 52 through the second switching valve 54. The operation valve 16 and the boom operation valve 17 are connected to each other through a parallel flow passage 20 provided in parallel with the neutral flow passage 19.

On a downstream side of the operation valve 18 for arm dual-speed in the neutral flow passage 19, a throttle 21 for pilot pressure control for generating the pilot pressure is provided. Since the throttle 21 functions similarly to the throttle 11, detailed description is omitted here.

Between the operation valve 18 and the throttle 21 in the neutral flow passage 19, a pilot flow passage 22 is connected. The pilot flow passage 22 is connected to a regulator 23 controlling a tilting angle of a swash plate of the second main pump 52.

The regulator 23 controls the tilting angle of the swash plate of the second main pump 52 so as to be in proportion (proportion constant is a negative number) to the pilot pressure and sets a working oil discharge amount per one rotation of the second main pump 52.

The control system 100 has a pressure sensor 42 for detecting a pressure supplied to the regulator 14 of the first main pump 51 and a pressure sensor 43 for detecting a pressure supplied to the regulator 23 of the second main pump 52. Pressure signals of the pressure sensor 42 and the pressure sensor 43 are input into the controller 60.

The controller 60 controls a tilting angle of a swash plate of the assist pump 44 in accordance with the pressure signals input from the pressure sensor 42 and the pressure sensor 43. A relationship between the pressure signals of the pressure sensor 42 and the pressure sensor 43 and the tilting angle of the swash plate of the assist pump 44 is set in advance so that the most efficient assist output can be obtained.

The boom cylinder 30 has a piston 30c defining a piston-side chamber (load-side pressure chamber) 30a and a rod-side chamber (anti-load side pressure chamber) 30b to/from which the working oil is fed/discharged therein and a piston rod 30d connecting the piston 30c and the boom. The boom cylinder 30 extends and raises (stands) the boom by supply of the working oil to the piston-side chamber 30a and contracts and lowers (falls) the boom by discharge of the working oil from the piston-side chamber 30a.

The boom operation valve 17 is a 6-port 3-position spool type operation valve. The boom operation valve 17 is operated by a pressure of the pilot pressure oil supplied to pilot chambers 17a and 17b through a pilot valve 62 from the pilot hydraulic source 56 on the basis of manual operation of an operation lever 61 by the operator of the hydraulic excavator. The operation valve 6 for boom dual-speed is switched in conjunction with the boom operation valve 17 when an operation amount of the operation lever 61 by the operator is larger than a predetermined amount.

When the pilot pressure oil is supplied to the pilot chamber 17a, the boom operation valve 17 is switched to a raised position (right-side position in FIG. 1). When the boom operation valve 17 is switched to the raised position, the discharged oil of the second main pump 52 is supplied to the piston-side chamber 30a of the boom cylinder 30 through a feeding/discharging flow passage 24, and a returning working oil from the rod-side chamber 30b is discharged to the tank 55 through a feeding/discharging flow passage 29. Thus, the boom cylinder 30 extends and the boom rises.

On the other hand, when the pilot pressure oil is supplied to the pilot chamber 17b, the boom operation valve 17 is switched to a lowered position (left-side position in FIG. 1). When the boom operation valve 17 is switched to the lowered position, the discharged oil from the second main pump 52 is supplied to the rod-side chamber 30b of the boom cylinder 30 through the feeding/discharging flow passage 29 and the returning working oil from the piston-side chamber 30a is discharged to the tank 55 through the feeding/discharging flow passage 24. Thus, the boom cylinder 30 contracts, and the boom lowers.

If the operator is not operating the operation lever 61 and the pilot pressure is not supplied to either of the pilot chambers 17a and 17b, the boom operation valve 17 is held at a neutral position (state illustrated in FIG. 1). If the boom operation valve 17 is held at the neutral position, feeding/discharging of the working oil to/from the boom cylinder 30 is shut off, and the boom holds a halted state.

In the feeding/discharging flow passage 24 for allowing the boom operation valve 17 and the piston-side chamber 30a to communicate, a regeneration control spool valve 26 as a regeneration flow rate control valve is provided. The regeneration control spool valve 26 is controlled by a pressure of the pilot pressure oil from the pilot hydraulic source 56 connected through a proportional solenoid valve 34 and controls a flow rate of the working oil discharged from the piston-side chamber 30a. The regeneration control spool valve 26 has a pilot chamber 26a faced with one of the spools and a spring 26b elastically supporting the other of the spools.

The regeneration control spool valve 26 has a normal position where the working oil of the piston-side chamber 30a is not discharged to the regeneration motor 45 and a regeneration position where the working oil of the piston-side chamber 30a is discharged to the regeneration motor 45.

The regeneration control spool valve 26 holds the normal position by an urging force of the spring 26b in a state where the pilot pressure oil is not supplied to the pilot chamber 26a (state illustrated in FIG. 1). The regeneration control spool valve 26 is switched to the regeneration position when the pilot pressure oil is supplied to the pilot chamber 26a.

The regeneration control spool valve 26 allows the feeding/discharging flow passage 24 to communicate in a state maintained at the normal position and shuts off a regeneration flow passage 27 connecting the piston-side chamber 30a of the boom cylinder 30 and the regeneration motor 45.

When the regeneration control spool valve 26 is switched to the regeneration position, it shuts off the feeding/discharging flow passage 24 and allows the regeneration flow passage 27 to communicate. As a result, connection between the piston-side chamber 30a and the boom operation valve 17 is shut off, and the piston-side chamber 30a and the regeneration flow passage 27 are connected.

For the regeneration control spool valve 26, two positions are illustrated and described for facilitating understanding. However, the regeneration control spool valve 26 does not select one of these two positions but has a function of holding both the feeding/discharging flow passage 24 and the regeneration flow passage 27 in a partial communication state in accordance with the pilot pressure of the pilot chamber 26a and of controlling their opening degrees in accordance with the pilot pressure.

In the regeneration flow passage 27, a check valve 28 for allowing a flow of the working oil discharged from the piston-side chamber 30a of the boom cylinder 30 to the regeneration motor 45 and preventing a flow in an opposite direction is provided.

The proportional solenoid valve 34 has a solenoid 34a and a spring 34b elastically supporting a valve body. The solenoid 34a is excited by a current from the controller 60 and drives the valve body against the spring 34b.

The proportional solenoid valve 34 holds the normal position by the urging force of the spring 34b when the solenoid 34a is in a non-excited state (state illustrated in FIG. 1). The proportional solenoid valve 34 is switched to a connection position when the excitation current is supplied to the solenoid 34a from the controller 60 and connects the pilot chamber 26a to the pilot hydraulic source 56 at an opening degree according to the excitation current. As described above, the pilot pressure of the pilot chamber 26a is controlled to a pressure according to the excitation current supplied from the controller 60 to the proportional solenoid valve 34.

The feeding/discharging flow passage 24 communicating with the piston-side chamber 30a of the boom cylinder 30 and the feeding/discharging flow passage 29 communicating with the rod-side chamber 30b of the boom cylinder 30 are connected through a regenerative flow passage 31 in which a regenerative flow rate control valve 32 is provided.

The regenerative flow rate control valve 32 is constituted by a spool valve. The regenerative flow rate control valve 32 has a pilot chamber 32a faced with one end of the spool and a spring 32b elastically supporting the other end of the spool.

The regenerative flow rate control valve 32 has a normal position where the working oil of the piston-side chamber 30a is not led to the rod-side chamber 30b and a regenerative position where the working oil of the piston-side chamber 30a is led to the rod-side chamber 30b. When the regenerative flow rate control valve 32 is switched to the regenerative position, a part of the working oil led to the tank 55 from the piston-side chamber 30a of the boom cylinder 30 when the boom is lowered is led as a regenerative flow rate to the rod-side chamber 30b of the boom cylinder 30.

The regenerative flow rate control valve 32 holds the normal position by the urging force of the spring 32b in a state where the pilot pressure oil is not supplied to the pilot chamber 32a (state illustrated in FIG. 1). The regenerative flow rate control valve 32 is switched to the regenerative position when the pilot pressure oil supplied to the pilot chamber 17b of the boom operation valve 17 from the pilot hydraulic source 56 is supplied to the pilot chamber 32a through a pilot communication flow passage 64.

The regenerative flow rate control valve 32 shuts off the regenerative flow passage 31 in a state maintained at the normal position (state illustrated in FIG. 1). When the regenerative flow rate control valve 32 is switched to the regenerative position, it controls a flow rate of the working oil of the regenerative flow passage 31 as a variable restrictor operating in accordance with the pilot pressure.

The regenerative flow rate control valve 32 and the regeneration control spool valve 26 are set so that timing at which the regenerative flow rate control valve 32 is switched to the regenerative position is slower than the timing at which the regeneration control spool valve 26 is switched to the regeneration position.

In the regenerative flow passage 31, a check valve 33 for allowing a flow of the working oil to the feeding/discharging flow passage 29 from the piston-side chamber 30a and preventing a flow in the opposite direction is provided.

The pilot communication flow passage 64 leads the pilot pressure oil supplied to the pilot chamber 17b of the boom operation valve 17 from the pilot hydraulic source 56 when the operator operates the operation lever 61 in order to lower the boom to the pilot chamber 32a of the regenerative flow rate control valve 32. That is, the pilot communication flow passage 64 allows the pilot chamber 17b of the boom operation valve 17 and the pilot chamber 32a of the regenerative flow rate control valve 32 to communicate. In the pilot communication flow passage 64, a solenoid three-way valve 65 as a switching valve for switching the pilot communication flow passage 64 between a communication state and a shut-off state is provided.

The solenoid three-way valve 65 is a solenoid-type switching valve having a solenoid 65a and a spring 65b elastically supporting a valve body. The solenoid 65a is excited by a current from the controller 60 and drives the valve body against the spring 65b.

The solenoid three-way valve 65 holds the normal position by the urging force of the spring 65b when the solenoid 65a is in a non-excited state and maintains the pilot communication flow passage 64 in a shut-off state (state illustrated in FIG. 1). The solenoid three-way valve 65 is switched to the communication position when the excitation current is supplied from the controller 60 to the solenoid 65a and brings the pilot communication flow passage 64 into the communication state. As described above, the solenoid three-way valve 65 switches between supply and shut-off of the pilot pressure oil to the pilot chamber 32a by the excitation current supplied to the solenoid 65a.

The solenoid three-way valve 65 is switched by an excitation signal supplied from the controller 60 to the solenoid 65a to the communication position after the hydraulic excavator is started and if a regeneration unit 50 which will be described later is in an operable state. When the operator wants to slow down the lowering speed of the boom, that is, when regenerating is not required, the solenoid three-way valve 65 is switched to the normal position by the controller 60 causing the solenoid 65a to be non-excited on the basis of the operation by the operator. As described above, the solenoid three-way valve 65 is for switching the pilot communication flow passage 64 between the communication state and the shut-off state by the operation by the operator. Moreover, the solenoid three-way valve 65 is switched to the normal position by the controller 60 causing the solenoid 65a to be non-excited when the regeneration unit 50 is in a non-operable state.

The control system 100 includes the regeneration unit 50 for recovering energy of the working oil discharged from the piston-side chamber 30a of the boom cylinder 30 in order to assist the supply of the working oil to each of the actuators from the first main pump 51 and the second main pump 52. The regeneration unit 50 will be described below.

The regeneration unit 50 has the regeneration motor 45 for regeneration rotated by the working oil discharged from the piston-side chamber 30a of the boom cylinder 30, a motor generator 35 as a rotating electric machine also serving as a power generator connected to the regeneration motor 45, an inverter 36 for converting electricity generated by the motor generator 35 to a direct current, and a battery 37 as a storage cell storing electricity generated by the motor generator 35. Regeneration control by the regeneration unit 50 is carried out by the controller 60.

The regeneration motor 45 is connected to the motor generator 35 and integrally rotated on the same axis with the assist pump 44. The motor generator 35 exerts a power generation function by being rotated/driven by the regeneration motor 45. The electricity generated by the motor generator 35 is charged to the battery 37 through the inverter 36. The battery 37 is connected to the controller 60, and a signal indicating SOC (State of Charge) of the battery 37 is input into the controller 60.

To the battery 37, a battery charger 38 is attached. The battery charger 38 charges the battery 37 by using the electricity generated by the power generator 3a. A power source 39 of another system such as a household power supply can be also connected to the battery charger 38.

The regeneration motor 45 regenerates electricity by being rotated by the working oil discharged from the piston-side chamber 30a. The regeneration motor 45 is a variable displacement type and includes a regulator 40 for controlling the tilting angle of the swash plate. The regulator 40 changes the tilting angle of the swash plate of the regeneration motor 45 in accordance with the signal from the controller 60.

The assist pump 44 is also a variable displacement type and includes a regulator 41 for controlling the tilting angle of the swash plate. The regulator 41 changes the tilting angle of the swash plate of the assist pump 44 in accordance with the signal from the controller 60.

If the regeneration motor 45 rotates/drives the motor generator 35, such a state can be set where a driving load of the assist pump 44 scarcely acts on the regeneration motor 45 by minimizing the tilting angle of the swash plate of the assists pump 44.

On the other hand, if the motor generator 35 is made to function as an electric motor, the assist pump 44 is rotated/driven by an output torque of the motor generator 35 and a driving torque of the regeneration motor 45 so as to make the assist pump 44 function as a pump. When the assist pump 44 is to be rotated/driven only by the output torque of the motor generator 35, the tilting angle of the swash plate of the regeneration motor 45 is minimized so as to minimize rotation resistance.

To an upstream of the regeneration motor 45, a pumping-up flow passage 57 for pumping up the working oil from the tank 55 to the regeneration flow passage 27 and supplying it to the regeneration motor 45 when the supply amount of the working oil to the regeneration motor 45 is not sufficient is connected. In the pumping-up flow passage 57, a check valve 57a for allowing only the flow of the working oil from the tank 55 to the regeneration flow passage 27 is provided.

An operation of the control system 100 will be described below.

In the control system 100, when the engine 3 is operated in a state where the solenoid 1a of the solenoid valve 1, the solenoid 2c of the solenoid valve 2a, and the solenoid 2d of the solenoid valve 2b are brought to a non-excited state, and the first switching valve 53 and the second switching valve 54 are held at the normal positions, respectively, the working oil is supplied from the first main pump 51 to the first circuit system 71, and the working oil is supplied from the second main pump 52 to the second circuit system 72.

At the same time, when the working oil is discharged from the assist pump 44, the discharged oil of the assist pump 44 is merged with the discharged oil of the first main pump 51 and the second main pump 52 and is supplied to the first circuit system 71 and the second circuit system 72.

On the other hand, when the first switching valve 53 is switched to the switching position, only the discharged oil of the first main pump 51 is supplied to the first circuit system 71. When the second switching valve 54 is switched to the first switching position, only the discharged oil of the second main pump 52 is supplied to the second circuit system 72.

When the second switching valve 54 is switched to a second switching position, the discharged oil of the second main pump 52 is supplied to the regeneration motor 45. Therefore, when the actuator connected to the second circuit system 72 is not operated, if the controller 60 switches the second switching valve 54 to the second switching position through the solenoid valve 2b, the regeneration motor 45 can be rotated so as to cause the motor generator 35 to generate power. The electricity generated by the motor generator 35 is charged to the battery 37 through the inverter 36.

Subsequently, an operation when the boom is lowered will be specifically described.

When the operator of the hydraulic excavator operates the operation lever 61, the pilot pressure oil from the pilot hydraulic source 56 is supplied to the pilot chamber 17b of the boom operation valve 17 through the pilot valve 62. As a result, the boom operation valve 17 is switched to a lowering position. [0082] When the boom operation valve 17 is switched to the lowering position, the discharged oil of the second main pump 52 is supplied to the rod-side chamber 30b, and the working oil of the piston side chamber 30a is discharged to the tank 55 so that the boom cylinder 30 contracts and the boom lowers. At this time, the controller 60 switches the proportional solenoid valve 34 to the connection position and starts a regeneration operation by the regeneration motor 45.

When the proportional solenoid valve 34 is switched to the connection position by a current from the controller 60, the pilot pressure oil from the pilot hydraulic source 56 is supplied to the pilot chamber 26a.

As the pilot pressure supplied to the pilot chamber 26a increases, the regeneration control spool valve 26 is switched from the normal position to the regeneration position. As a result, the working oil of the piston-side chamber 30a of the boom cylinder 30 is discharged to the regeneration flow passage 27 and is led to the regeneration motor 45.

When the solenoid three-way valve 65 has been switched to the communication position and the pilot communication flow passage 64 is in the communication state, the pilot pressure oil from the pilot hydraulic source 56 supplied to the pilot chamber 17b of the boom operation valve 17 is supplied to the pilot chamber 32a of the regenerative flow rate control valve 32 through the pilot communication flow passage 64. As a result, regenerating by leading a part of the working oil of the piston-side chamber 30a to the rod-side chamber 30b when the boom is lowered is performed. Thus, even if the lowering speed of the boom cylinder 30 becomes faster, the rod-side chamber 30b is suppressed from becoming a negative pressure, and occurrence of a noise can be prevented.

Here, if the operator of the hydraulic excavator wants to make adjustment so that the lowering speed of the boom cylinder 30 is slowed, the controller 60 brings the solenoid 65a of the solenoid three-way valve 65 to the non-excited state on the basis of the operation by the operator. As a result, the solenoid three-way valve 65 is switched to the normal position, and the pilot communication flow passage 64 for allowing the pilot chamber 17b of the boom operation valve 17 and the pilot chamber 32a of the regenerative flow rate control valve 32 to communicate is switched to the shut-off state. At this time, though the pilot pressure is led to the pilot chamber 17b of the boom operation valve 17 on the basis of the operation by the operator, the pilot pressure is not led to the pilot chamber 32a of the regenerative flow rate control valve 32. Thus, since a part of the working oil is not led from the piston-side chamber 30a to the rod-side chamber 30b, an operating speed of the boom cylinder 30 can be adjusted so as to be the same as that when regenerating is not performed. Therefore, adjustment of operability of the boom cylinder 30 by the operator can be facilitated.

Moreover, if the regeneration unit 50 fails, for example, the controller 60 brings the solenoid 34a of the proportional solenoid valve 34 to a non-excited state. As a result, the proportional solenoid valve 34 is switched to the normal position, and the pilot pressure oil from the pilot hydraulic source 56 is no longer supplied to the pilot chamber 26a of the regeneration control spool valve 26. Thus, the working oil is no longer supplied to the regeneration motor 45.

At this time, the controller 60 brings the solenoid 65a of the solenoid three-way valve 65 to a non-excited state. As a result, the solenoid three-way valve 65 is switched to the normal position, and the pilot pressure oil from the pilot hydraulic source 56 is no longer supplied to the pilot chamber 32a of the regenerative flow rate control valve 32. Thus, regenerating by leading a part of the working oil of the piston-side chamber 30a to the rod-side chamber 30b is no longer performed.

As described above, when the regeneration unit 50 fails, the regeneration unit 50 can be separated from the control system 100 and thus, operation characteristics of the hydraulic excavator can be made the same as those of the normal hydraulic excavator which is not a hybrid hydraulic excavator.

Moreover, by using the solenoid three-way valve 65 which is switchable depending on an excited state of the solenoid 65a, the controller 60 detects a failure of the regeneration unit 50 and automatically switches the solenoid three-way valve 65 to the normal position not relying on the operation by the operator and can bring the pilot communication flow passage 64 to a shut-off state.

According to the first embodiment described above, the following effects are exerted.

When the solenoid three-way valve 65 is switched to the normal position, the pilot communication flow passage 64 for allowing the pilot chamber 17b of the boom operation valve 17 and the pilot chamber 32a of the regenerative flow rate control valve 32 to communicate is shut off. As a result, even if the pilot pressure is led to the pilot chamber 17b of the boom operation valve 17 on the basis of the operation by the operator, the pilot pressure is not led to the pilot chamber 32a of the regenerative flow rate control valve 32. Thus, since a part of the working oil is not led to the rod-side chamber 30b from the piston-side chamber 30a, the operating speed of the boom cylinder 30 can be adjusted so as to be the same as that when regenerating is not performed. Therefore, adjustment of operability of the boom cylinder 30 by the operator can be facilitated.

### Second Embodiment

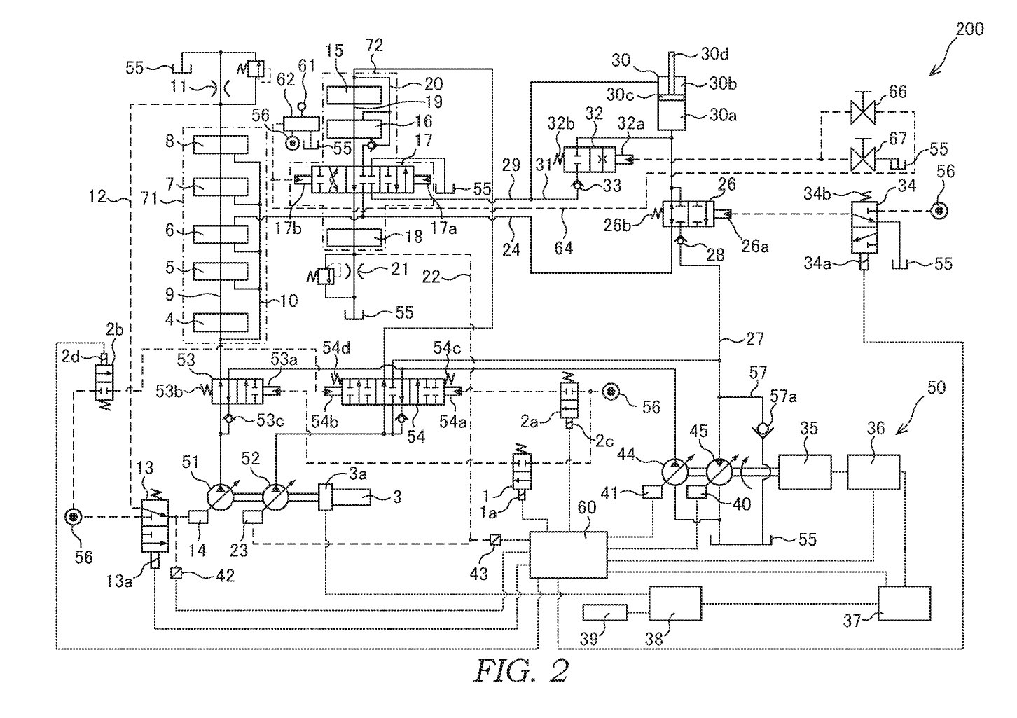

A control system for the construction machine (hereinafter simply referred to as a “control system”) 200 according to a second embodiment of the present invention will be described below by referring to FIG. 2. In the second embodiment illustrated below, points different from those in the aforementioned first embodiment will be mainly described, and the same reference numerals are given to constitution having a function similar to that in the first embodiment, and description will be omitted.

In the control system 200, instead of the solenoid three-way valve 65, a pair of manual opening/closing valves 66 and 67 are used as switching valves, which is different from the first embodiment.

The manual opening/closing valves 66 and 67 are needle valves which can be opened/closed manually by the operator of the hydraulic excavator. The manual opening/closing valve 66 is interposed in the pilot communication flow passage 64. The manual opening/closing valve 67 is switched to a closed state in order to maintain the pilot pressure of the pilot communication flow passage 64 when the manual opening/closing valve 66 is in an open state. The manual opening/closing valve 67 is switched to the open state in order to discharge the pilot pressure oil supplied to the pilot chamber 32a to the tank 55 when the manual opening/closing valve 66 is in the closed state.

When the manual opening/closing valve 66 is in the open state, the pilot communication flow passage 64 is in the communication state. Thus, the pilot pressure oil from the pilot hydraulic source 56 supplied to the pilot chamber 17b of the boom operation valve 17 is supplied to the pilot chamber 32a of the regenerative flow rate control valve 32 through the pilot communication flow passage 64. As a result, regenerating by leading a part of the working oil of the piston-side chamber 30a to the rod-side chamber 30b when the boom is lowered is performed.

On the other hand, if the manual opening/closing valve 66 is switched to the closed state, the pilot pressure oil from the pilot hydraulic source 56 is no longer supplied to the pilot chamber 32a of the regenerative flow rate control valve 32. Thus, regenerating by leading a part of the working oil of the piston-side chamber 30a to the rod-side chamber 30b is no longer performed.

The needle valves are used as the manual opening/closing valves 66 and 67, but it is only necessary that the pilot communication flow passage 64 is shut off and thus, other valves such as a ball valve, a poppet valve and the like may be used.

In the second embodiment described above, the working effect similar to those in the first embodiment is exerted, and if the operator of the hydraulic excavator feels a sense of discomfort while performing an operation of lowering the boom, the operator can manually bring the pilot communication flow passage 64 to the shut-off state.

Constitution, operations, and effects of the embodiments of the present invention will be described in summary below.

The control systems 100 and 200 have the first and second main pumps 51 and 52 supplying the working oil, the boom cylinder 30 having the piston-side chamber 30a and the rod-side chamber 30b to/from which the working oil from the first and second main pumps 51 and 52 are fed/discharged, has the boom operation valve 17 which is switched so as to supply the working oil from the first and second main pumps 51 and 52 to the rod-side chamber 30b and to discharge the working oil from the piston-side chamber 30a when the pilot pressure is led to the pilot chamber 17b, the pilot chamber 17b to which the pilot pressure is led on the basis of the operation by the operator, and the pilot chamber 32a to which the pilot pressure is led, and includes the regenerative flow rate control valve 32 switched so as to lead a part of the working oil discharged from the piston-side chamber 30a to the rod-side chamber 30b when the pilot pressure is led to the pilot chamber 32a, the pilot communication flow passage 64 for allowing the pilot chamber 17b of the boom operation valve 17 and the pilot chamber 32a of the regenerative flow rate control valve 32 to communicate, and the solenoid three-way valve 65 or the manual opening-closing valves 66 and 67 switching the pilot communication flow passage 64 between the communication state and the shut-off state.

In this constitution, when the solenoid three-way valve 65 or the manual opening/closing valves 66 and 67 are switched, the pilot communication flow passage 64 for allowing the pilot chamber 17b of the boom operation valve 17 and the pilot chamber 32a of the regenerative flow rate control valve 32 to communicate is shut off. As a result, even if the pilot pressure is led to the pilot chamber 17b of the boom operation valve 17 on the basis of the operation by the operator, the pilot pressure is not led to the pilot chamber 32a of the regenerative flow rate control valve 32. Thus, since a part of the working oil is not led from the piston-side chamber 30a to the rod-side chamber 30b, the boom cylinder 30 can be adjusted so as to be the same as that when regenerating is not performed. Therefore, adjustment of operability of the boom cylinder 30 by the operator can be facilitated.

Moreover, the control system 100 further includes the controller 60 for controlling the operation of the hydraulic excavator, and the solenoid three-way valve 65 is a solenoid switching valve for switching the pilot communication flow passage 64 to the shut-off state by the controller 60 when the regenerating of leading the working oil from the piston-side chamber 30a to the rod-side chamber 30b is not necessary.

According to this constitution, by using the solenoid three-way valve 65 which is a solenoid switching valve, the controller 60 detects a failure of the regeneration unit 50 and automatically switches the solenoid three-way valve 65 not relying on the operation by the operator and can bring the pilot communication flow passage 64 to a shut-off state.

Moreover, the solenoid three-way valve 65 and the manual opening/closing valves 66 and 67 switch the pilot communication flow passage 64 between the communication state and the shut-off state by the operation by the operator.

According to this constitution, by switching the pilot communication flow passage 64 between the communication state and the shut-off state by the operation by the operator, the operating speed of the boom cylinder 30 can be adjusted in accordance with a request of the operator.

Moreover, the regeneration unit 50 for recovering energy of the working oil discharged from the piston-side chamber 30a in order to assist the supply of the working oil from the first and second main pumps 51 and 52 to the boom cylinder 30 is further included.

Moreover, the solenoid three-way valve 65 or the manual opening/closing valves 66 and 67 switch the pilot communication flow passage 64 to the thus-off sate when the regeneration unit 50 is in a non-operable state.

According to these constitutions, when the regeneration unit 50 is in a non-operable state, the pilot communication flow passage 64 is switched to the shut-off state and thus, in the case of a failure of the regeneration unit 50, the pilot communication flow passage 64 is held in the shut-off state. Thus, in the case of a failure of the regeneration unit 50, the regeneration unit 50 can be separated from the control system 100 by not performing regenerating, either. Therefore, the operation characteristics of the hydraulic excavator can be made the same as those of the normal hydraulic excavator which is not a hybrid hydraulic excavator.

Embodiments of this invention were described above, but the above embodiments are merely examples of applications of this invention, and the technical scope of this invention is not limited to the specific constitutions of the above embodiments.

For example, in the aforementioned embodiment, as an example of performing regeneration by using the returning working oil from the fluid pressure cylinder, the case of using the returning working oil from the boom cylinder 30 is described. However, instead of the boom cylinder 30, the regeneration may be performed by using the returning working oil from the arm cylinder for arm driving or the bucket cylinder for bucket driving. The arm cylinder and the bucket cylinder are often in a state holding the load by the rod-side chamber when the operation valves 5 and 16 are at the neutral positions and thus, the rod-side chamber may be used as a load-side pressure chamber.

Moreover, in the aforementioned first embodiment, the solenoid three-way valve 65 switched by the controller 60 is used as the switching valve. Instead of this, the pilot switching valve switched by a pilot secondary pressure generated by reduction by the proportional solenoid valve 34 of a pressure of the pilot pressure oil supplied from the pilot hydraulic source 56 in accordance with the excitation current may be used as the switching valve, for example.

This application claims priority to Japanese Patent Application No. 2015-129852 filed in the Japanese Patent Office on Jun. 29, 2015, the entire contents of which are incorporated by reference herein.

1. A control system for a construction machine, comprising:
a fluid pressure pump configured to supply a working fluid;
a fluid pressure actuator having a load-side pressure chamber and an anti-load side pressure chamber to/from which the working fluid from the fluid pressure pump is fed/discharged;
an operation valve having a pilot chamber to which a pilot pressure is led on the basis of an operation by an operator, the operation valve being switched to supply the working fluid to the anti-load side pressure chamber from the fluid pressure pump and to discharge the working fluid from the load-side pressure chamber when the pilot pressure is led to the pilot chamber;
a regenerative flow rate control valve having a pilot chamber to which a pilot pressure is led, the regenerative flow rate control valve being switched to lead a part of the working fluid discharged from the load-side pressure chamber to the anti-load side pressure chamber when the pilot pressure is led to the pilot chamber;
a pilot communication flow passage configured to allow the pilot chamber of the operation valve and the pilot chamber of the regenerative flow rate control valve to communicate; and
a switching valve configured to switch the pilot communication flow passage between a communication state and a shut-off state.

2. The control system for a construction machine according to claim 1, further comprising:
a control part configured to control an operation of the construction machine, wherein
the switching valve is a solenoid switching valve configured to switch the pilot communication flow passage to the shut-off state by the control part when regenerating of leading the working fluid from the load-side pressure chamber to the anti-load side pressure chamber is not needed.

3. The control system for a construction machine according to claim 1, wherein
the switching valve switches the pilot communication flow passage by the operation by the operator between the communication state and the shut-off state.

4. The control system for a construction machine according to claim 1, further comprising:
a regeneration unit configured to recover energy of the working fluid discharged from the load-side pressure chamber in order to assist supply of the working fluid from the fluid pressure pump to the fluid pressure actuator.

5. The control system for a construction machine according to claim 4, wherein
the switching valve switches the pilot communication flow passage to the shut-off state when the regeneration unit is in a non-operable state.
